(19) United States
(12) Patent Application Publication
(10) Pub. No.: US 2024/0223086 A1
(43) Pub. Date: Jul. 4, 2024

(54) BUCK-BOOST SWITCHING CONVERTER AND CONTROL METHOD THEREOF

(71) Applicant: Richtek Technology Corporation, Hsinchu (TW)

(72) Inventors: Kuo-Chi Liu, Hsinchu (TW); Ta-Yung Yang, Taoyuan (TW)

(21) Appl. No.: 18/471,266

(22) Filed: Sep. 20, 2023

Related U.S. Application Data
(60) Provisional application No. 63/477,553, filed on Dec. 28, 2022.

(30) Foreign Application Priority Data
Jul. 7, 2023 (TW) 112125366

(51) Int. Cl. H02M 3/158; H02M 1/00; H02M 3/07

(52) U.S. Cl. CPC H02M 3/1582; H02M 1/0009; H02M 1/0058; H02M 3/07

(57) ABSTRACT

A buck-boost switching converter for converting the power between a first and a second voltage, includes: a first sub-converter coupled between the first voltage and a first switching node, which includes a first plural switches and a capacitor; and a second sub-converter coupled between the second voltage and a second switching node, which includes a second plural switches. The first and second plural switches switch the capacitor and an inductor periodically, so as to divide the first voltage using the capacitor by a switched-capacitor (SC) voltage division method, and to switch the first switching node between a reference voltage and a voltage division of the first voltage, and to switch the second switching node between at least two voltages. The reference voltage is the first voltage, a ground or another voltage division of the first voltage. One of the at least two voltages is related to the second voltage.

### CROSS REFERENCE

The present invention claims priority to U.S. 63/477,553 filed on Dec. 28, 2022 and claims priority to TW 112125366 filed on Jul. 7, 2023.

### BACKGROUND OF THE INVENTION

### Field of Invention

The present invention relates to a buck-boost switching converter and a control method thereof, in particular to a buck-boost switching converter and a control method which can operate in various switching states and have high conversion efficiency.

### Description of Related Art

Conventional arts related to the present invention include: “Buck-Boost DC-DC switching power conversion” (U.S. Pat. No. 6,788,033B2), and “Three-Level Buck Converter for Envelope Tracking in RF Power Amplifiers” (IEEE).

Please refer to FIG. 1, which shows a power converter of the conventional art. The power converter 900 in FIG. 1 is a 3-level buck switching converter for converting the input voltage Vi into the output voltage Vo. The power converter 900 periodically switches the capacitor Cx and the inductor L between a plurality of electrical connection states through the switches M1-M4, such that the capacitor Cx performs the switched-capacitor switching over the input voltage Vi to make the node Ny been switched between one-half of the input voltage Vi (voltage across the capacitor Cx in a steady state) and ground potential, or switched between one-half of the input voltage Vi and the input voltage Vi, whereby converting the input voltage Vi into the output voltage Vo.

Compared with the traditional 2-level buck switching converter, although the above-mentioned conventional art can reduce the switching loss and the ripple of the output current, in the configuration of the 3-level buck switching converter, the output voltage Vo must be lower than the input voltage Vi. In other words, under the condition that the switching loss must be reduced, the conventional art is limited in buck power conversion, but not be operable with other power conversions such as boost power conversion or buck-boost power conversion.

In view of this, the present invention aims at the deficiencies of the above-mentioned conventional art, and proposes an innovative buck-boost switching converter and its control method, which can not only reduce switching losses, improve conversion efficiency, but also be operable in boost mode, buck mode, and buck-boost mode operating states, such that the output voltage does not need to be limited to be lower than the input voltage, and a higher voltage difference between the output voltage and the input voltage is also allowed.

### SUMMARY OF THE INVENTION

From one perspective, the present invention provides a buck-boost switching converter, configured to perform power conversion between a first voltage at a first power node and a second voltage at a second power node, the buck-boost switching converter comprising: a first sub-converter, coupled between the first power node and a first switching node, wherein the first sub-converter is a first switched-capacitor converter which includes a first group of plural switches and a first capacitor; and a second sub-converter, which is coupled between a second switching node and the second power node, and includes a second group of plural switches; wherein the first group of plural switches and the second group of plural switches are configured to periodically switch the first capacitor and an inductor between a plurality of electrical connection states based on a switching frequency according to a plurality of switching signals, wherein the inductor is coupled between the first switching node and the second switching node; wherein the plurality of switching signals switch the first capacitor between the plurality of electrical connection states to perform a switched-capacitor voltage division on the first voltage, so as to switch the first switching node between a first reference potential and a divided voltage of the first voltage obtained by the switched-capacitor voltage division, and switching the second switching node between at least two potentials, thereby performing power conversion between the first voltage and the second voltage; wherein the first reference potential is the first voltage, a ground potential, or another divided voltage of the first voltage; and wherein one of the at least two potentials is related to the second voltage.

In one embodiment, the first voltage is greater than, equal to, or lower than the second voltage.

In one embodiment, the second group of plural switches includes: a high-side switch, coupled between the inductor and the second voltage; and a low-side switch, coupled between the inductor and the ground potential; wherein in a boost mode or a buck-boost mode, the inductor is periodically switched by the high-side switch and the low-side switch, such that the second switching node switches between the second voltage and the ground potential.

In one embodiment, the second sub-converter is a second switched-capacitor converter and further includes a second capacitor; wherein the second switched-capacitor converter operates the second capacitor to perform switched-capacitor switching over the second voltage to switch the second switching node between a divided voltage of the second voltage and a second reference potential; and wherein the second reference potential is the second voltage, the ground potential, or another divided voltage of the second voltage.

In one embodiment, the first group of plural switches includes four switches for periodically switching the first capacitor according to the plurality of switching signals, such that the first capacitor is switched between a one-half of the first voltage and the first voltage, or switching the first switching node between the one-half of the first voltage and the ground potential.

In one embodiment, the switching frequency is related to a resonant frequency, such that the buck-boost switching converter operates in a resonant mode to control a voltage ratio of the second voltage to the first voltage to be related to a voltage division ratio of the divided voltage of the first voltage to the first voltage, wherein the resonant frequency is related to a capacitance of the first capacitor and an inductance of the inductor.

In one embodiment, the buck-boost switching converter further comprises a control circuit configured to operably generate the plurality of switching signals, wherein the control circuit includes a zero-current detection circuit coupled to the inductor to generate a zero-current signal according to a zero-current time point in which an inductor current flowing through the inductor is zero-current; and wherein the plurality of switching signals switch a corresponding first group of plural switches and/or the second group of plural switches subsequent to the zero-current time point indicated by the zero-current signal, so as to switch the plurality of electrical connection states.

In one embodiment, the plurality of switching signals further adjust a conduction time of the first group of plural switches and/or the second group of plural switches according to the zero-current signal; and/or, the plurality of switching signals further adjust the switching frequency according to a dead-time after the zero-current time point of the zero-current signal, wherein the inductor current is zero during an electrical connection state within the dead-time.

In one embodiment, the switching frequency is much higher than a resonant frequency to an extent, such that the buck-boost switching converter operates in a non-resonant mode, thereby regulating the second voltage at a predetermined level, wherein the resonant frequency is related to the capacitance of the first capacitor and the inductance of the inductor.

In one embodiment, the first sub-converter is operated in a boost mode, a buck mode, a buck-boost mode, or a bypass mode according to the plurality of switching signals and a voltage conversion ratio between the second voltage and the first voltage.

In one embodiment, the first group of plural switches and/or the second group of plural switches are turned on during a constant conduction time according to the plurality of switching signals, wherein a switching period corresponding to the switching frequency is determined according to the first voltage, the second voltage and a load, or according to the zero-current signal.

In one embodiment, when an inductor current flowing through the inductor is zero or close to zero, a part of switches of the first group of plural switches and/or a part of switches of the second group of plural switches are turned off to achieve zero-current switching (ZCS).

In one embodiment, a part of switches of the first group of plural switches and/or a part of switches of the second group of plural switches are turned off after a delay time when an inductor current flowing through the inductor reaches zero-current, thereby generating a reverse current to achieve zero voltage switching (ZVS).

From another perspective, the present invention provides a control method of a buck-boost switching converter, the buck-boost switching converter comprising a plurality of switches, configured to perform power conversion between a first voltage at a first power node and a second voltage at a second power node, wherein the control method comprises: periodically switching the first capacitor and an inductor between a plurality of electrical connection states based on a switching frequency according to a plurality of switching signals; and switching the first capacitor between the plurality of electrical connection states to perform a switched-capacitor voltage division on the first voltage, so as to switch the first switching node between a first reference potential and a divided voltage of the first voltage obtained by the switched-capacitor voltage division, and switching the second switching node between at least two potentials, thereby performing power conversion between the first voltage and the second voltage; wherein the first reference potential is the first voltage, a ground potential, or another divided voltage of the first voltage; wherein one of the at least two potentials is related to the second voltage.

The objectives, technical details, features, and effects of the present invention will be better understood with regard to the detailed description of the embodiments below, with reference to the attached drawings.

### BRIEF DESCRIPTION OF THE DRAWINGS

FIG. 1 shows a power converter of a conventional art.

FIG. 2 shows a block diagram of a buck-boost switching converter according to an embodiment of the present invention.

FIG. 3 shows a schematic diagram of a buck-boost switching converter according to a specific embodiment of the present invention.

FIG. 4 shows a schematic diagram of a buck-boost switching converter according to an embodiment of the present invention.

FIG. 5 shows a schematic diagram of a buck-boost switching converter according to an embodiment of the present invention.

FIG. 6 shows a comparison table according to an embodiment of a plurality of electrical connection states in the buck-boost switching conversion circuit shown in FIG. 5.

FIG. 7 shows an operation waveform diagram corresponding to the embodiment of the buck-boost switching converter shown in FIG. 5.

FIG. 8 shows an operation waveform diagram corresponding to the embodiment of the buck-boost switching converter shown in FIG. 5.

FIG. 9A shows an operation waveform diagram corresponding to the embodiment of the buck-boost switching converter of FIG. 5.

FIG. 9B shows an operation waveform diagram corresponding to the embodiment of the buck-boost switching converter of FIG. 5.

FIG. 10 shows an operation waveform diagram corresponding to the embodiment of the buck-boost switching converter of FIG. 5.

FIG. 11 shows a waveform diagram of a portion of switching signals and an inductor current signal of another embodiment corresponding to the buck-boost switching converter of FIG. 7.

FIG. 12 shows a block diagram of a buck-boost switching converter according to another embodiment of the present invention.

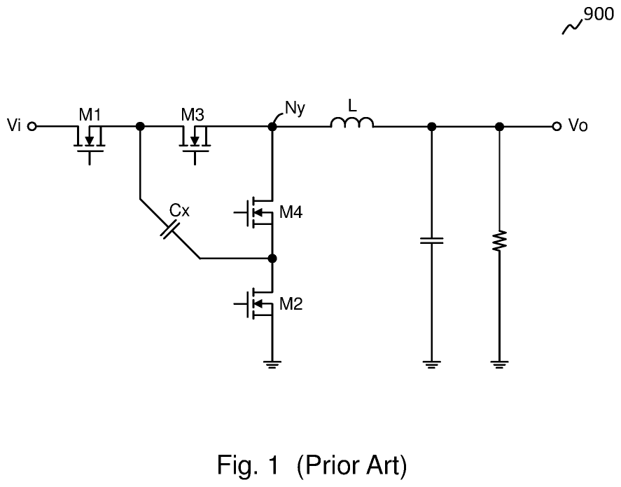

### DESCRIPTION OF THE PREFERRED EMBODIMENTS

The drawings as referred to throughout the description of the present invention are for illustration only, to show the interrelations between the circuits and the signal waveforms, but not drawn according to actual scale of circuit sizes and signal amplitudes and frequencies.

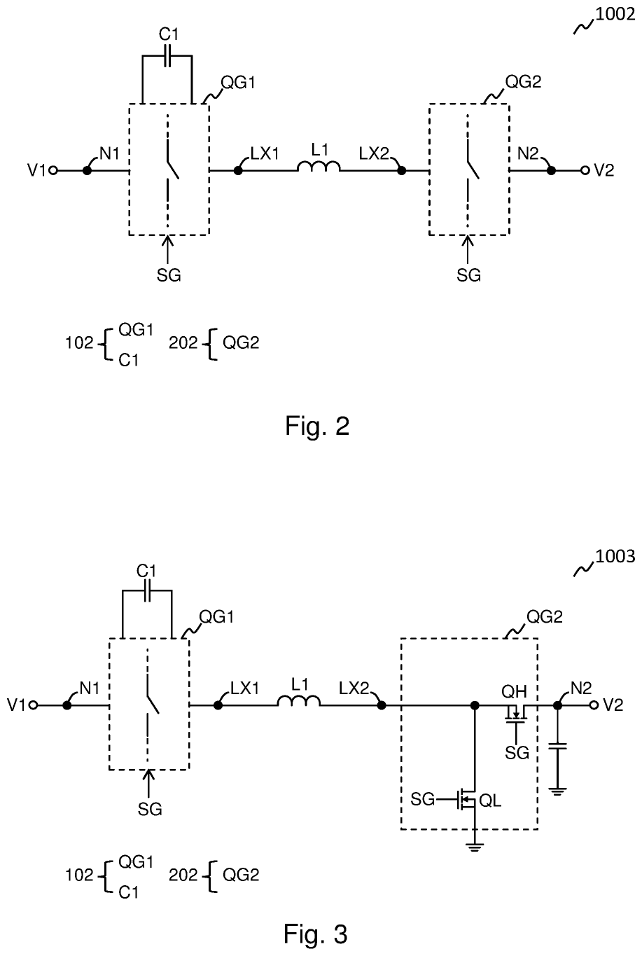

Please refer to FIG. 2. FIG. 2 shows a block diagram of a buck-boost switching converter according to an embodiment of the present invention. As shown in FIG. 2, in one embodiment, the buck-boost switching converter 1002 is configured to perform power conversion between the first voltage V1 of the first power node N1 and the second voltage V2 of the second power node N2. In one embodiment, the buck-boost switching converter 1002 includes: a first sub-converter 102, a second sub-converter 202 and an inductor L1. In one embodiment, the first sub-converter 102 is coupled between the first power node N1 and the first switching node LX1, the inductor L1 is coupled between the first switching node LX1 and the second switching node LX2, and the second sub-converter 202 is coupled between the second switching node LX2 and the second power node N2. In one embodiment, the first voltage V1 is greater than, equal to, or less than the second voltage V2.

In one embodiment, the first sub-converter 102 is configured as a first switched-capacitor converter, including a first group of plural switches QG1 and a first capacitor C1. In one embodiment, the second sub-converter 202 includes a second group of plural switches QG2. In one embodiment, the first group of plural switches QG1 and the second group of plural switches QG2 are configured to periodically switch the first capacitor C1 and the inductor L1, based on a switching frequency, between plural electrical connection states according to a plurality of switching signals SG.

In one embodiment, the plurality of switching signals SG are configured to switch the first capacitor C1 between plural electrical connection states to perform switched-capacitor switching over the first voltage V1 (for example, performing a switched-capacitor voltage division on the first voltage V1), to switch the first switching node LX1 between a divided voltage of the first voltage V1 and the first reference potential, and to switch the second switching node LX2 between at least two potentials, thereby performing power conversion between the first voltage V1 and the second voltage V2. In one embodiment, the first reference potential is the first voltage V1, the ground potential, or another divided voltage of the first voltage V1. In one embodiment, one of the at least two potentials is related to the second voltage V2. The plurality of electrical connection states will be described in detail in subsequent embodiments.

Please refer to FIG. 3. FIG. 3 shows a schematic diagram of a buck-boost switching converter according to an embodiment of the present invention. In the buck-boost switching converter 1003 of FIG. 3, the second group of plural switches QG2 of the second sub-converter 202 includes: a high-side switch QH and a low-side switch QL. In the present embodiment, the high-side switch QH and the low-side switch QL are N-type metal oxide semiconductor (MOS) transistors. In one embodiment, the high-side switch QH is coupled between the inductor L1 and the second voltage V2, and the low-side switch QL is coupled between the inductor L1 and the ground potential. In a boost mode, or in a buck-boost mode, the inductor L1 is periodically switched by the high-side switch QH and the low-side switch QL, such that the second switching node LX2 is switched between the second voltage V2 and the ground potential. In another embodiment, in a buck mode, the high-side switch QH is always on, and the low-side switch QL is always off.

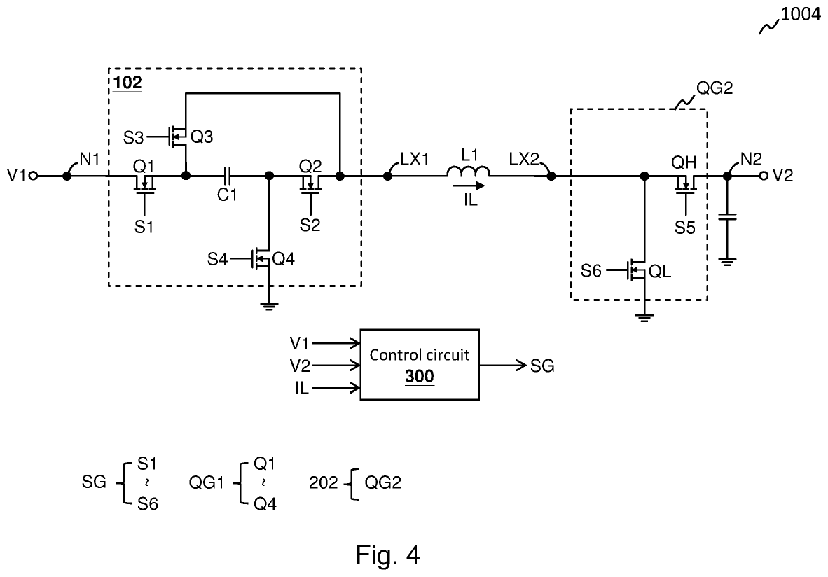

Please refer to FIG. 4. FIG. 4 shows a schematic diagram of a buck-boost switching converter according to a specific embodiment of the present invention. The buck-boost switching converter 1004 in FIG. 4 is similar to the buck-boost switching converter 1003 in FIG. 3. In one embodiment, the first group of plural switches QG1 in the first sub-converter 102 in FIG. 4 include switches Q1-Q4. In the present embodiment, the switches Q1-Q4 are all N-type metal oxide semiconductor (MOS) transistors. In one embodiment, the buck-boost switching converter 1004 in FIG. 4 further includes a control circuit 300 for generating the plurality of switching signals SG according to the first voltage V1, the second voltage V2, and the inductor current IL flowing through the inductor L1. In the present embodiment, the plurality of switching signals SG include switching signals S1-S6, which are configured to control the switching of the switches Q1-Q4, the high-side switch QH, and the low-side switch QL, respectively.

In one embodiment, as shown in FIG. 4, the switch Q1, the switch Q3, the switch Q2, and the switch Q4 are sequentially coupled in series between the first power node N1 and the ground potential, and the first capacitor C1 is coupled between the source of the switch Q1 and the source of the switch Q2 (that is, between the drain of the switch Q3 and the drain of the switch Q4). In the present embodiment, the first switch node LX1 is coupled to the source of the switch Q3 (i.e., the drain of the switch Q2). In one embodiment, the switches Q1-Q4 are periodically switched according to the switching signals S1-S4, respectively, so as to perform switched-capacitor switching over the first voltage V1, such that the voltage across the first capacitor C1 in the steady state is substantially equal to one-half of the first voltage V1. In one embodiment, by periodically switching the first capacitor C1 through the switches Q1-Q4, the first switching node LX1 is switched between one-half of the first voltage V1 and the first voltage V1, or the first switching node LX1 is switched between one-half of the first voltage V1 and the ground potential.

It is noteworthy that, in the embodiment of FIG. 4, the first sub-converter 102 is configured as a converter including four switches and one capacitor, such that the first switching node LX1 is switched between one-half of the first voltage V1 and the first voltage V1 or the ground potential. In other embodiments, when the numbers and configurations of the first group of plural switches QG1 and capacitors of the first sub-converter 102 are different, the first switching node LX1 can be switched between a divided voltage of the first voltage V1, the first voltage V1, another divided voltage of the first voltage V1, or a ground potential.

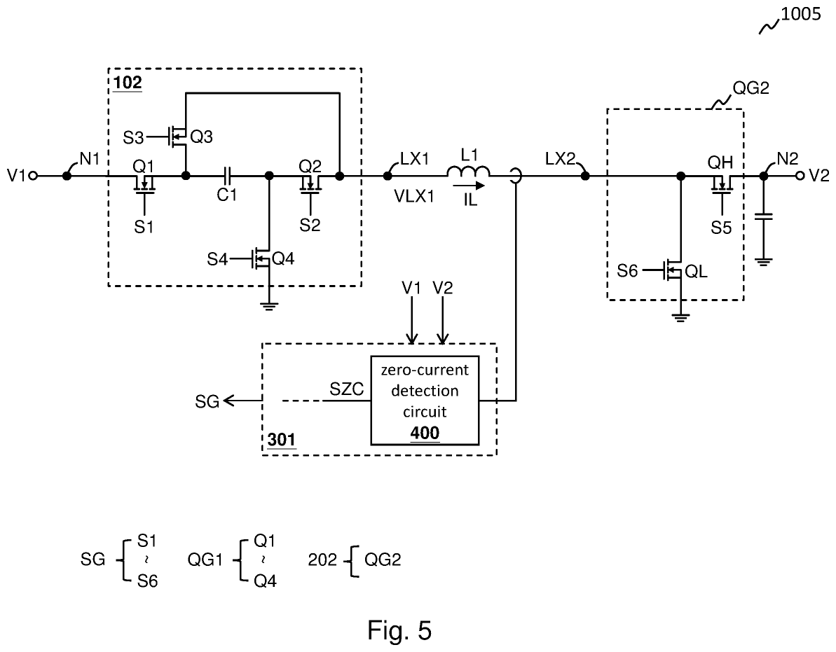

Please refer to FIG. 5, which shows a schematic diagram of a buck-boost switching converter according to an embodiment of the present invention. The buck-boost switching converter 1005 of FIG. 5 is similar to the buck-boost switching converter 1004 of FIG. 4. In one embodiment, the control circuit 301 of FIG. 5 includes a zero-current detection circuit 400 coupled to the inductor L1 to generate the zero-current signal SZC according to the zero-current time point when the inductor current IL is zero-current. In one embodiment, the plurality of switching signals SG switch a corresponding first group of plural switches QG1 and/or the second group of plural switches QG2 subsequent to the zero-current time point indicated by the zero-current signal SZC, so as to switch the plurality of electrical connection states. The specific operation will be described in subsequent embodiments.

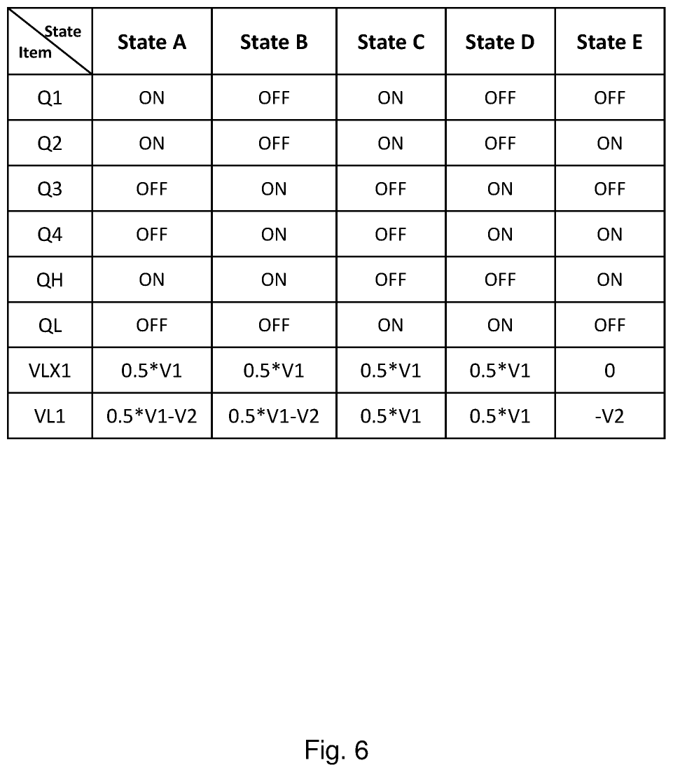

Please refer to FIG. 5 together with FIG. 6. FIG. 6 shows a comparison table according to an embodiment of the plural electrical connection states in the buck-boost switching converter shown in FIG. 5. In one embodiment, the aforementioned plural electrical connection states include but are not limited to states A to E. In the states A to E, the conduction or non-conduction states of the switches Q1-Q4, the high-side switch QH, and the low-side switch QL are shown in FIG. 6. In addition, FIG. 6 also shows the DC voltage value of the first switching voltage VLX1 on the first switching node LX1 and the DC voltage value of the cross-voltage VL1 on the inductor L1 in the states A to E. It is noteworthy that in the present embodiment, in the buck-boost switching convertor of the present invention, during a switching period, the first capacitor C1 and the inductor L1 will switch between more than two states among the states A to E. For details, please refer to the description of the following operation waveform diagram.

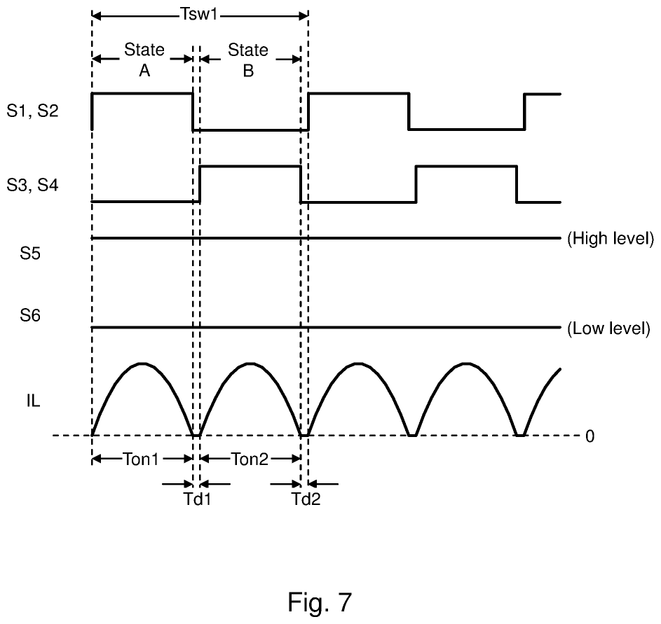

Please refer to FIGS. 5 to 7 at the same time. FIG. 7 shows an operation waveform diagram corresponding to the embodiment of the buck-boost switching convertor shown in FIG. 5. In one embodiment, the first capacitor C1 and the inductor L1 have a resonant frequency when resonating with each other, and the resonant frequency is related to the capacitance of the first capacitor C1 and the inductance of the inductor L1. In the embodiments of FIG. 5 and FIG. 7, the switching frequency corresponding to the switching period Tsw1 is related to the resonant frequency. In one embodiment, the switching frequency corresponding to the switching period Tsw1 is equal to the resonant frequency. It is noteworthy that, under the condition that the switching frequency is related to (for example, equal to) the resonant frequency, in the embodiment of FIG. 7, the buck-boost switching converter 1005 operates in a resonant mode.

In the embodiment shown in FIG. 7, the high-side switch QH is kept conducting according to the switching signal S5, and the low-side switch QL is kept not conducting according to the switching signal S6. In the switching period Tsw1, the switching signals S1-S4 respectively control the switches Q1 and Q2 to conduct during the conduction time Ton1 subsequent to the zero-current time point indicated by the zero-current signal SZC, and respectively control the switches Q3 and Q4 to conduct during the conduction time Ton2, such that the buck-boost switching converter 1005 operates in state A and state B during the conduction time Ton1 and Ton2, respectively (refer to FIG. 6 for the conduction state of each switch). In the present embodiment, both the conduction time Ton1 and the conduction time Ton2 are approximately equal to one-half of the switching period Tsw1. In the present embodiment, the switching signals S1-S4 further control the switching of the switches Q1-Q4 according to the dead-times Td1 and Td2 after the zero-current time point to prevent component from shoot-through. Specifically, within the dead-time (such as Td1, Td2), any one among the switches Q1-Q4, the high-side switch QH, and the low-side switch QL that needs to change state must be controlled to be non-conducting during the dead-time (such as Td1, Td2) to prevent from short circuit between the switches.

It is noteworthy that in the embodiment of FIG. 7, the first capacitor C1 and the inductor L1 are switched between state A and state B, thereby enabling the buck-boost switching converter 1005 to operate in the buck mode. Specifically, in one embodiment, in state A, the first capacitor C1 and the inductor L1 are coupled in series between the first voltage V1 and the second voltage V2, such that the first capacitor C1 is charged, and the inductor L1 undergoes a cycle of magnetizing and demagnetizing in the form of a sinusoidal wave (in the resonant mode). In state B, the first capacitor C1 and the inductor L1 are coupled in series between the ground potential and the second voltage V2, such that the first capacitor C1 is discharged, and the inductor L1 undergoes a cycle of magnetizing and demagnetizing in the form of a sinusoidal wave (in resonance mode).

Please continue to refer to FIG. 5 and FIG. 7. From one perspective, in the embodiment of FIG. 7, the buck-boost switching converter 1005 operates in the resonant mode to control a voltage ratio of the second voltage V2 to the first voltage V1 to be related to a voltage division ratio of the divided voltage of the first voltage V1 to the first voltage V1. In one embodiment, the buck-boost switching converter 1005 operates in a resonant mode, thereby controlling the voltage ratio of the second voltage V2 to the first voltage V1 to be 1:2.

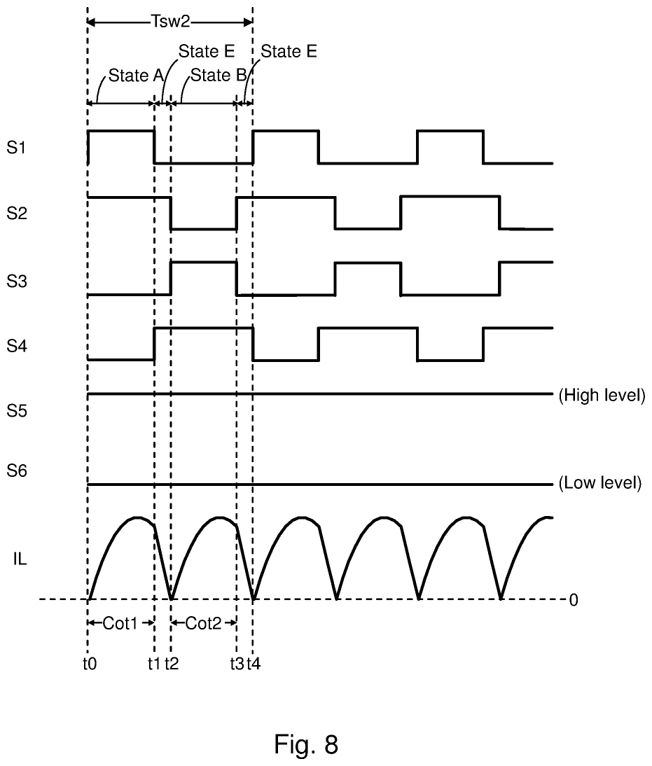

Please refer to FIG. 5 together with FIG. 6 and FIG. 8. FIG. 8 shows an operation waveform diagram corresponding to the embodiment of the buck-boost switching converter in FIG. 5. The embodiment in FIG. 8 is similar to the embodiment in FIG. 7, the switching frequency corresponding to the switching period Tsw2 is related to the resonant frequency of the first capacitor C1 and the inductor L1. In other words, the present embodiment also operates in the resonant mode. In the embodiment of FIG. 8, the high-side switch QH keeps conduction according to the switching signal S5, and the low-side switch QL keeps non-conduction according to the switching signal S6. In the switching period Tsw2, the switching signals S1-S4 respectively control the switching of the switches Q1-Q4, such that the buck-boost switching converter 1005 operates sequentially in the state A, the state E, the state B, and the state E (for the conduction state of each switch, please refer to FIG. 6). In one embodiment, the switching signals S1-S4 are generated according to the constant conduction time Cot1, Cot2, and the zero-current time point indicated by the zero-current signal SZC. In one embodiment, the constant conduction time Cot1 is equal to the constant conduction time Cot2.

It is noteworthy that, in the embodiment of FIG. 8, the first capacitor C1 and the inductor L1 are switched alternately in state A, state E, state B, and state E, thereby enabling the buck-boost switching converter 1005 to operate in the buck mode. Specifically, in the state A during time points t0-t1 and the state B during time points t2-t3, the coupling states of the first capacitor C1 and the inductor L1 can be referred to the description of FIG. 7. In one embodiment, in the state E between the time points t1-t2 or between the time points t3-t4, the inductor L1 is coupled between the ground potential and the second voltage V2, such that the inductor L1 is demagnetizing.

It is also noteworthy that the embodiment of FIG. 8 is similar to the embodiment of FIG. 7 in that the switching frequency corresponding to the switching period Tsw2 is related to the resonant frequency of the first capacitor C1 and the inductor L1. In other words, the present embodiment also operates in the resonant mode. In the resonant mode, the switching states can either a resonant switching state or a non-resonant switching state. Taking the present embodiment as an example, state A and state B are resonant switching states, and state E is a non-resonant switching state. Specifically, in state A and state B, the inductor L1 and the first capacitor C1 resonate by mutual energy exchange during these switching states (such as t0-t1 or t2-t3). On the other hand, during the state E (such as t1-t2 or t3-t4), the inductor L1 and the first capacitor C1 do not resonate with each other. From one perspective, in the resonant mode, the buck-boost switching converter of the present invention can be switched between different resonant switching states (as shown in FIG. 7), or can be switched between the resonant switching state and the non-resonant switching state (as shown in FIG. 8).

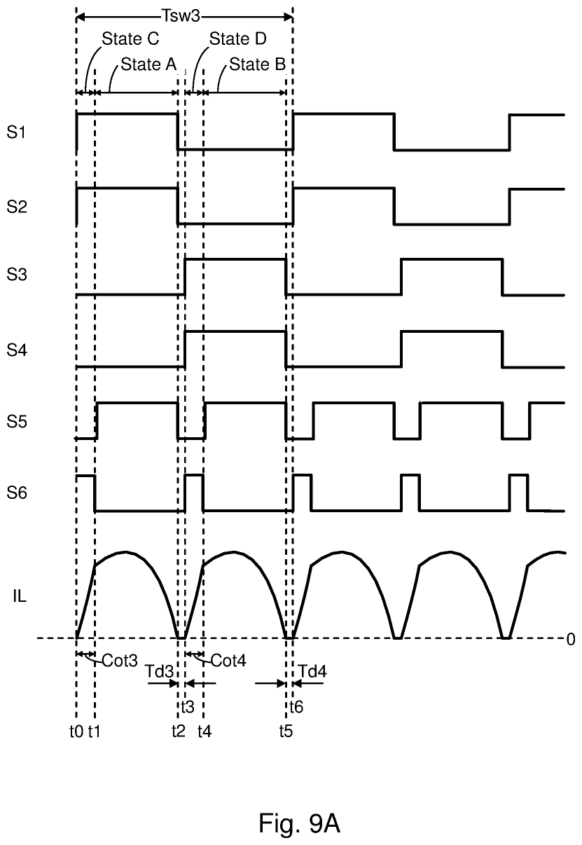

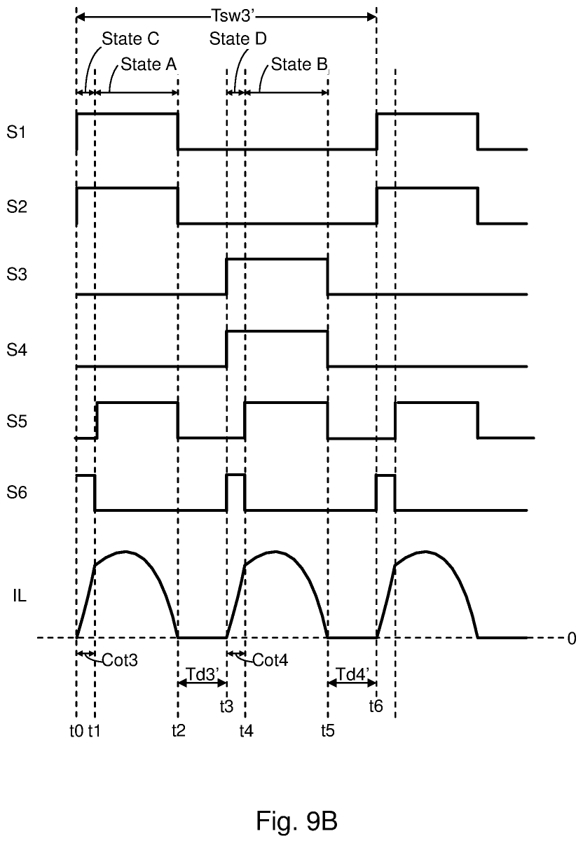

Please refer to FIG. 5 together with FIG. 6 and FIG. 9A. FIG. 9A shows an operation waveform diagram of the embodiment of the buck-boost switching converter corresponding to FIG. 5. The embodiment of FIG. 9A is similar to the embodiment of FIG. 7 in that the switching frequency corresponding to the switching period Tsw3 is related to the resonant frequency of the first capacitor C1 and the inductor L1. In other words, in the present embodiment, the buck-boost switching converter 1005 operates in the resonant mode.

In the embodiment of FIG. 9A, in the switching period Tsw2, the switching signals S1-S6 respectively control the switching of the switches Q1-Q4, the high-side switch QH, and the low-side switch QL, such that the buck-boost switching converter 1005 is operated sequentially in the state C, the state A, the state D, and the state B during the switching period Tsw3 (the conduction state of each switch referring to FIG. 6). In the present embodiment, the switching signals S1-S6 control the switching of the switches Q1-Q4 according to the dead-time Td3, Td4 subsequent to the zero-current time point, so as to prevent components from shoot-through. In one embodiment, the switching signals S1-S6 are generated according to the constant conduction times Cot3, Cot4 and the zero-current time point indicated by the zero-current signal SZC. For example, the period of the state C corresponds to the constant conduction time Cot3, and the period of the state D corresponds to the constant conduction time Cot4. In one embodiment, the constant conduction time Cot3 is equal to the constant conduction time Cot4.

It is noteworthy that, in the embodiment of FIG. 9A, the first capacitor C1 and the inductor L1 are switched between state C, state A, state D, and state B, thereby enabling the buck-boost switching converter 1005 to operate in the boost mode. Specifically, please refer to the description of FIG. 7 for the coupling states of the first capacitor C1 and the inductor L1 in the state A between the time points t1-t2 and the state B between the time points t4-t5. In one embodiment, in the state C between the time points t0-t1, the first capacitor C1 and the inductor L1 are coupled in series between the first voltage V1 and the ground potential, such that the first capacitor C1 is charged and the inductor L1 undergoes magnetizing in the form of a sinusoidal wave. In the state D between the time points t3-t4, the first capacitor C1 and the inductor L1 are coupled in parallel to the ground potential, such that the first capacitor C1 discharges to magnetize the inductor L1. It is noteworthy that the state C and the state D are resonant switching states. However, in the present embodiment, as shown in FIG. 9A, since the periods of state C and state D are both less than ¼ period of the resonant sinusoidal wave, therefore in the state C and state D of the present embodiment, the inductor L1 only undergoes magnetizing in the form of a sinusoidal wave and does not include a demagnetization process. On the other hand, the state A and the state B respectively follow the state C and the state D, such that the inductor L1 undergoes a cycle of magnetizing and demagnetizing in the form of a sinusoidal wave.

Please refer to FIG. 9A and FIG. 9B simultaneously. FIG. 9B shows an operation waveform diagram corresponding to the embodiment of the buck-boost switching converter in FIG. 5. The embodiment of FIG. 9B is similar to the embodiment of FIG. 9A and differs in that in one embodiment, the switching signals S1-S6 further adjust the switching period according to a dead-time after the zero-current time point of the zero-current signal SZC, thereby adjusting the switching frequency related to the switching period. Specifically, in the embodiment of FIG. 9B, the switching period is adjusted by extending the dead-time, that is, the dead-times Td3′ and Td4′ of FIG. 9B are greater than the dead-times Td3 and Td4 of FIG. 9A. Therefore, the switching period Tsw′ of FIG. 9B is greater than the switching period Tsw of FIG. 9A, thereby adjusting the switching frequency corresponding to the switching period Tsw′. In one embodiment, since the dead-time starts after the zero-current time point, the inductor current IL is zero during the electrical connection states within the dead-times Td3′ and Td4′.

It is noteworthy that in the embodiments of FIG. 7, FIG. 8, and FIG. 9A, the switching signals S1-S6 control the switches Q1-Q4, the high-side switch QH, and the low-side switch QL according to the zero-current signal SZC to make the buck-boost switching converter to operate in the boundary conduction mode (BCM). In the embodiment of FIG. 9B, by extending the dead-time, the inductor current IL is kept at zero-current for a certain period of time, thereby enabling the buck-boost switching converter to operate in a discontinuous conduction mode (DCM).

It is also noteworthy that in the embodiments of FIGS. 7, 8, 9A and 9B, when the inductor current IL flowing through the inductor L1 is zero or close to zero, a part of switches of the first group of plural switches QG1 (Q1-Q4) and/or a part of switches of the second group of plural switches QG2 (QH, QL) are turned off to achieve zero-current switching (ZCS) of soft switching.

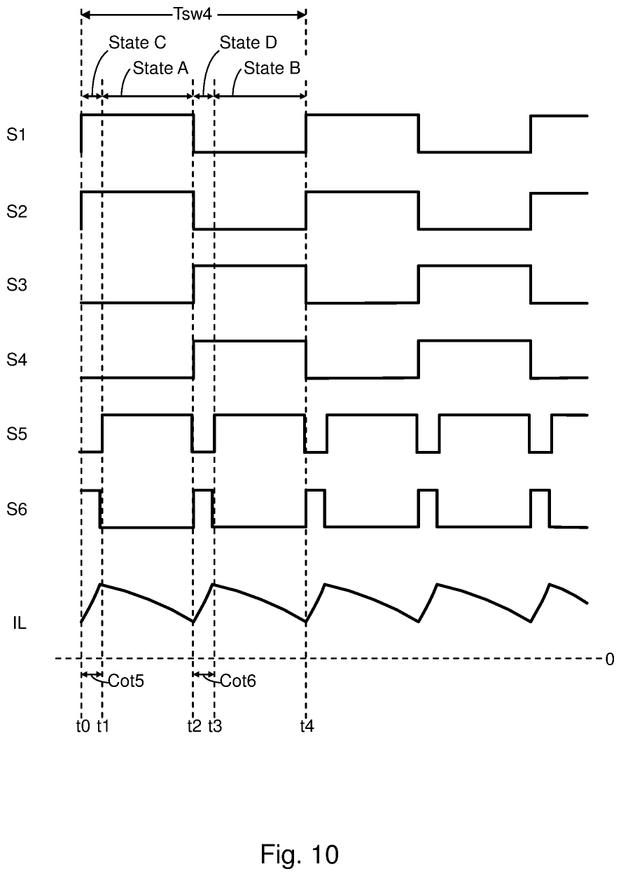

Please refer to FIG. 5 together with FIG. 6 and FIG. 10. FIG. 10 shows an operation waveform diagram corresponding to the embodiment of the buck-boost switching converter of FIG. 5. The embodiment of FIG. 10 is similar to the embodiment of FIG. 9A. In one embodiment, the switching signals S1-S6 respectively control the switching of the switches Q1-Q4, the high-side switch QH and the low-side switch QL, such that the buck-boost switching converter 1005 is operated sequentially in the state C, the state A, the state D, and the state B during the switching period Tsw4 (the conduction state of each switch referring to FIG. 6). In one embodiment, the switching signals S1 to S6 are generated according to constant conduction times Cot5 and Cot6. For example, the period of the state C corresponds to the constant conduction time Cot5, and the period of the state D corresponds to the constant conduction time Cot6. In one embodiment, the constant conduction time Cot5 is equal to the constant conduction time Cot6.

The difference between the embodiments of FIG. 10 and FIG. 9A is that in the embodiment shown in FIG. 10, the switching signals S1-S6 are further adjusted through feedback to control the switching of the switches Q1-Q4 and the high-side switch QH and the low-side switch QL (for example, at time points t2 and t4). In other words, the switching period Tsw4 is determined according to the first voltage V1, the second voltage V2, and the load. In addition, in the embodiment of FIG. 10, the switching frequency corresponding to the switching period Tsw4 is much higher than the resonant frequency to an extent, such that the buck-boost switching converter 1005 operates in a non-resonant mode, thereby regulating the second voltage V2 to a predetermined level. It is noteworthy that in the non-resonant mode, the state A and the state B as shown in the figure are both non-resonant switching states. Specifically, since the periods of state A and state B are both much shorter than the resonance period, the voltage of the first capacitor C1 can be considered to be substantially constant. Therefore, in both state A and state B, the inductor L1 is under a demagnetization process.

It is noteworthy that in the embodiment of FIG. 10, the switching signals S1-S6 control the switching duty cycle of the switches Q1-Q4, the high-side switch QH, and the low-side switch QL according to the feedback adjustment. In the present embodiment, the buck-boost switching converter operates in the buck-boost mode and is in the continuous conduction mode (CCM).

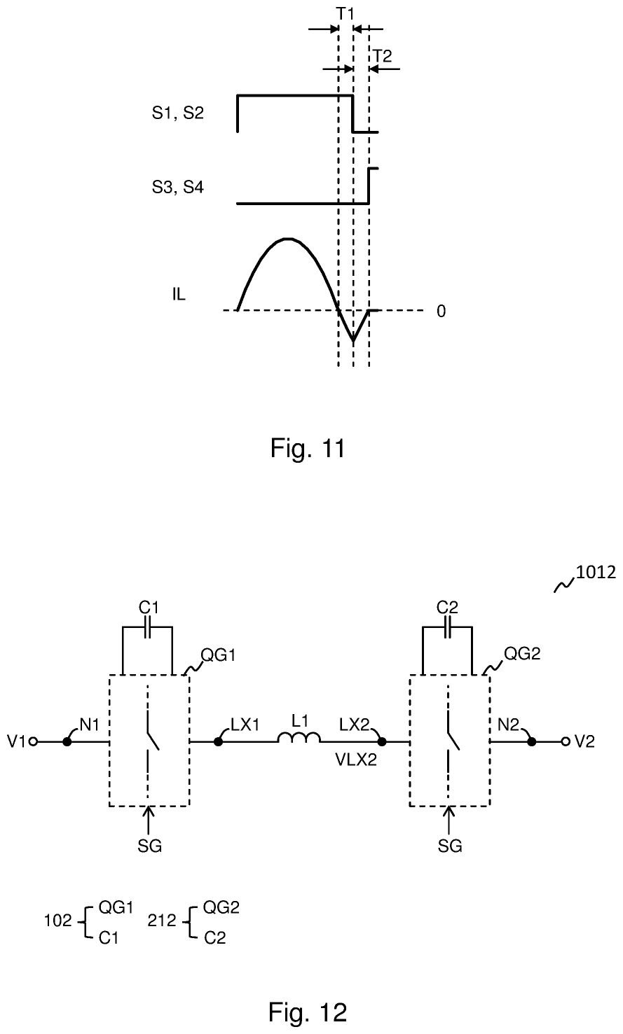

Please refer to FIG. 11 which shows a signal waveform diagram of a part of the switching signal and the inductor current corresponding to another embodiment of the buck-boost switching converter of FIG. 7. In one embodiment, the switching signals S1 and S2 does not turn to a low level until a delay time T1 subsequent to the inductor current IL reaching zero current, thereby delaying the time point for the switches Q1 and Q2 to turn off, such that the inductor current IL has a negative current. In the present embodiment, the negative current flows through the body diode of the switch Q3 to reduce the cross-voltage of the switch Q3, and the switch Q3 turns on according to the switching signal S3 after the delay time T2, thereby achieving zero-voltage switching (ZVS) of soft switching. It is noteworthy that in other embodiments, the negative current of the inductor current IL in FIG. 5 can alternatively achieve zero-voltage switching of the switches Q1 and Q3 or the low-side switch Q6.

Please refer to FIG. 12, which shows a block diagram of a buck-boost switching converter according to another embodiment of the present invention. The buck-boost switching converter 1012 of FIG. 12 is similar to the buck-boost switching converter 1002 of FIG. 2. In one embodiment, the second sub-converter 212 in the buck-boost switching converter 1012 is configured as a second switched-capacitor converter, the second sub-converter 212 further includes a second capacitor C2. In one embodiment, the plural switching signals SG further operate the second capacitor C2 to perform switched-capacitor switching over the second voltage V2 or perform switched-capacitor switching over the second switching voltage VLX2 on the second switching node LX2, between the plural electrical connection states. In one embodiment, the second capacitor C2 is configured, for example, to perform switched-capacitor switching over the second voltage V2 (for example, performing switched-capacitor voltage division on the second voltage V2).

In summary, the buck-boost switching converter of the present invention can not only reduce switching losses and improve conversion efficiency through the first sub-converter and the second sub-converter, but also can be operated in the operating states of the boost mode, buck mode or buck-boost mode. In addition, the buck-boost switching converter of the present invention can convert in both directions, that is, it can convert the first voltage into the second voltage, or the second voltage into the first voltage. The first voltage can be greater than, equal to, or less than the second voltage, without the restriction that the second voltage needs to be less than the first voltage.

The present invention has been described in considerable detail with reference to certain preferred embodiments thereof. It should be understood that the description is for illustrative purpose, not for limiting the broadest scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, to perform an action “according to” a certain signal as described in the context of the present invention is not limited to performing an action strictly according to the signal itself, but can be performing an action according to a converted form or a scaled-up or down form of the signal, i.e., the signal can be processed by a voltage-to-current conversion, a current-to-voltage conversion, and/or a ratio conversion, etc. before an action is performed. It is not limited for each of the embodiments described hereinbefore to be used alone; under the spirit of the present invention, two or more of the embodiments described hereinbefore can be used in combination. For example, two or more of the embodiments can be configured together, or, a part of one embodiment can be configured to replace a corresponding part of another embodiment. In view of the foregoing, the spirit of the present invention should cover all such and other modifications and variations, which should be interpreted to fall within the scope of the following claims and their equivalents.

What is claimed is:

1. A buck-boost switching converter, configured to perform power conversion between a first voltage at a first power node and a second voltage at a second power node, the buck-boost switching converter comprising:
a first sub-converter, coupled between the first power node and a first switching node, wherein the first sub-converter is a first switched-capacitor converter which includes a first group of plural switches and a first capacitor; and
a second sub-converter, which is coupled between a second switching node and the second power node, and includes a second group of plural switches;
wherein the first group of plural switches and the second group of plural switches are configured to periodically switch the first capacitor and an inductor between a plurality of electrical connection states based on a switching frequency according to a plurality of switching signals, wherein the inductor is coupled between the first switching node and the second switching node;
wherein the plurality of switching signals switch the first capacitor between the plurality of electrical connection states to perform a switched-capacitor voltage division on the first voltage, so as to switch the first switching node between a first reference potential and a divided voltage of the first voltage obtained by the switched-capacitor voltage division, and switching the second switching node between at least two potentials, thereby performing power conversion between the first voltage and the second voltage;
wherein the first reference potential is the first voltage, a ground potential, or another divided voltage of the first voltage; and
wherein one of the at least two potentials is related to the second voltage.

2. The buck-boost switching converter of claim 1, wherein the first voltage is greater than, equal to, or lower than the second voltage.

3. The buck-boost switching converter of claim 1, wherein the second group of plural switches includes:
a high-side switch, coupled between the inductor and the second voltage; and
a low-side switch, coupled between the inductor and the ground potential;
wherein in a boost mode or a buck-boost mode, the inductor is periodically switched by the high-side switch and the low-side switch, such that the second switching node switches between the second voltage and the ground potential.

4. The buck-boost switching converter of claim 1, wherein the second sub-converter is a second switched-capacitor converter and further includes a second capacitor;
wherein the second switched-capacitor converter operates the second capacitor to perform switched-capacitor switching over the second voltage to switch the second switching node between a divided voltage of the second voltage and a second reference potential; and
wherein the second reference potential is the second voltage, the ground potential, or another divided voltage of the second voltage.

5. The buck-boost switching converter of claim 3, wherein the first group of plural switches includes four switches for periodically switching the first capacitor according to the plurality of switching signals, such that the first capacitor is switched between a one-half of the first voltage and the first voltage, or switching the first switching node between the one-half of the first voltage and the ground potential.

6. The buck-boost switching converter of claim 1, wherein the switching frequency is related to a resonant frequency, such that the buck-boost switching converter operates in a resonant mode to control a voltage ratio of the second voltage to the first voltage to be related to a voltage division ratio of the divided voltage of the first voltage to the first voltage, wherein the resonant frequency is related to a capacitance of the first capacitor and an inductance of the inductor.

7. The buck-boost switching converter of claim 1, further comprising a control circuit configured to operably generate the plurality of switching signals, wherein the control circuit includes a zero-current detection circuit coupled to the inductor to generate a zero-current signal according to a zero-current time point in which an inductor current flowing through the inductor is zero-current; and
wherein the plurality of switching signals switch a corresponding first group of plural switches and/or the second group of plural switches subsequent to the zero-current time point indicated by the zero-current signal, so as to switch the plurality of electrical connection states.

8. The buck-boost switching converter of claim 7, wherein the plurality of switching signals further adjust a conduction time of the first group of plural switches and/or a conduction time of the second group of plural switches according to the zero-current signal; and/or,
the plurality of switching signals further adjust the switching frequency according to a dead-time after the zero-current time point of the zero-current signal, wherein the inductor current is zero during an electrical connection state within the dead-time.

9. The buck-boost switching converter of claim 1, wherein the switching frequency is much higher than a resonant frequency to an extent, such that the buck-boost switching converter operates in a non-resonant mode, thereby regulating the second voltage at a predetermined level, wherein the resonant frequency is related to the capacitance of the first capacitor and the inductance of the inductor.

10. The buck-boost switching converter of claim 1, wherein the first sub-converter is operated in a boost mode, a buck mode, a buck-boost mode, or a bypass mode according to the plurality of switching signals and a voltage conversion ratio between the second voltage and the first voltage.

11. The buck-boost switching converter of claim 7, wherein the first group of plural switches and/or the second group of plural switches are turned on during a constant conduction time according to the plurality of switching signals, wherein a switching period corresponding to the switching frequency is determined according to the first voltage, the second voltage and a load, or according to the zero-current signal.

12. The buck-boost switching converter of claim 1, wherein when an inductor current flowing through the inductor is zero or close to zero, a part of switches of the first group of plural switches and/or a part of switches of the second group of plural switches are turned off to achieve zero-current switching (ZCS).

13. The buck-boost switching converter of claim 1, wherein a part of switches of the first group of plural switches and/or a part of switches of the second group of plural switches are turned off after a delay time when an inductor current flowing through the inductor reaches zero-current, thereby generating a reverse current to achieve zero voltage switching (ZVS).

14. A control method of a buck-boost switching converter, the buck-boost switching converter comprising a plurality of switches, configured to perform power conversion between a first voltage at a first power node and a second voltage at a second power node, wherein the control method comprises:
periodically switching the first capacitor and an inductor between a plurality of electrical connection states based on a switching frequency according to a plurality of switching signals; and
switching the first capacitor between the plurality of electrical connection states to perform a switched-capacitor voltage division on the first voltage, so as to switch the first switching node between a first reference potential and a divided voltage of the first voltage obtained by the switched-capacitor voltage division, and switching the second switching node between at least two potentials, thereby performing power conversion between the first voltage and the second voltage;
wherein the first reference potential is the first voltage, a ground potential, or another divided voltage of the first voltage;
wherein one of the at least two potentials is related to the second voltage.

15. The control method of claim 14, wherein the first voltage is greater than, equal to, or less than the second voltage.

16. The control method of claim 14, further comprising: periodically switching the inductor in a boost mode or in a buck-boost mode, such that the second switching node is switched between the second voltage and the ground potential.

17. The control method of claim 14, wherein the second sub-converter is a second switched-capacitor converter and further includes a second capacitor; wherein the control method further comprises:
operating the second capacitor to perform switched-capacitor switching over the second voltage to switch the second switching node between a divided voltage of the second voltage and a second reference potential; and
wherein the second reference potential is the second voltage, the ground potential, or another divided voltage of the second voltage.

18. The control method of claim 16, further comprising: periodically switching the first capacitor according to the plurality of switching signals, such that the first switching node is switched between a one-half of the first voltage and the first voltage, or the first switching node is switched between the one-half of the first voltage and the ground potential.

19. The control method of claim 14, wherein the switching frequency is related to a resonant frequency, such that the buck-boost switching converter operates in a resonant mode to control a voltage ratio of the second voltage to the first voltage to be related to a voltage division ratio of the divided voltage of the first voltage to the first voltage, wherein the resonant frequency is related to a capacitance of the first capacitor and an inductance of the inductor.

20. The control method of claim 14, further comprising:
generating a zero-current signal according to a zero-current time point in which an inductor current flowing through the inductor is zero-current; and
switching the plurality of electrical connection states subsequent to the zero-current time point indicated by the zero-current signal.

21. The control method of claim 20, further comprising:
controlling the plurality of switching signals to adjust a conduction time of the plurality of switches further according to the zero-current signal; and/or,
controlling the plurality of switching signals to adjust the switching frequency further according to a dead-time after the zero-current time point of the zero-current signal, wherein the inductor current is zero during an electrical connection state within the dead-time.

22. The control method of claim 14, wherein the switching frequency is much higher than a resonant frequency to an extent, such that the buck-boost switching converter operates in a non-resonant mode, thereby regulating the second voltage at a predetermined level, wherein the resonant frequency is related to the capacitance of the first capacitor and the inductance of the inductor.

23. The control method of claim 14, further comprising: operating the buck-boost switching converter operate in a boost mode, a buck mode, or a buck-boost mode by the plurality of switching signals.

24. The control method of claim 20, further comprising: controlling the plural switches to be turned on during a constant conduction time according to the plurality of switching signals, wherein a switching period corresponding to the switching frequency is determined according to the first voltage, the second voltage and a load, or according to the zero-current signal.

25. The control method of claim 14, further comprising: controlling a part of switches of the plural switches to turn off when an inductor current flowing through the inductor is zero or close to zero, so as to achieve zero-current switching (ZCS).

26. The control method of claim 14, further comprising: controlling a part of switches of the plural switches to turn off after a delay time when an inductor current flowing through the inductor reaches zero-current, thereby generating a reverse current to achieve zero voltage switching (ZVS).
